(19) United States
(12) Patent Application Publication
(10) Pub. No.: US 2001/0052252 A1
(43) Pub. Date: Dec. 20, 2001

(54) Security device

(76) Inventors: Donald William Farmer, Western Australia (AU); Lyle Eric Radecker, Western Australia (AU)

Correspondence Address: LEWIS F. GOULD, JR., DUANE MORRIS & HECKSCHER, LLP, ONE LIBERTY PLACE, PHILADELPHIA, PA, 19103, US

(21) Appl. No.: 09/880,635

(22) Filed: Jun. 13, 2001

(30) Foreign Application Priority Data
Jun. 14, 2000 (AU) PO8132

(51) Int. Cl. E05B 65/12

(52) U.S. Cl. 70/285

(57) ABSTRACT

A security device for boats, caravans, trailers and such like comprises an upright member with means for engaging an attachment means to secure a boat, caravan, trailer and such like. The device is provided with a pivotable member configurable in a first secured configuration and a second unsecured configuration In the first secured configuration the pivotable member prevents the attachment means from being disengaged from the upright member. In the second unsecured configuration the pivotable member allows the attachment means to be disengaged from the upright member. The upright member is also pivotable between a first upright position and a second substantially horizontal reclined position.

The present invention relates to a security device, in particular to a security device for securing boats, trailers, caravans, and similar vehicles.

As the relative affluence and leisure time of citizens of industrialized nations increases, so too, the accoutrements of leisure activities such as boats, trailers, caravans, and similar vehicular attachments increasingly become a common feature of the suburban landscape. Boats, trailer or caravan are frequently parked in suburban driveways and roadsides with little more than a rope tied around a tree to prevent a thief from coupling a vehicle to the boat, trailer or caravan and removing them from the owner's premises.

The present invention attempts to overcome at least in part some of the aforementioned disadvantages.

In accordance with one aspect of the present invention there is provided a security device for boats, caravans, trailers and such like, comprising an upright member with means for engaging an attachment means to secure a boat, caravan, trailer or such like, and a pivotable member configurable in a first secured configuration and a second unsecured configuration, wherein in the first secured configuration the pivotable member prevents the attachment means from being disengaged from the upright member and in the second unsecured configuration the pivotable member allows the attachment means to be disengaged from the upright member.

The present invention will now be described, by way of example only, with reference to the accompanying drawings, in which

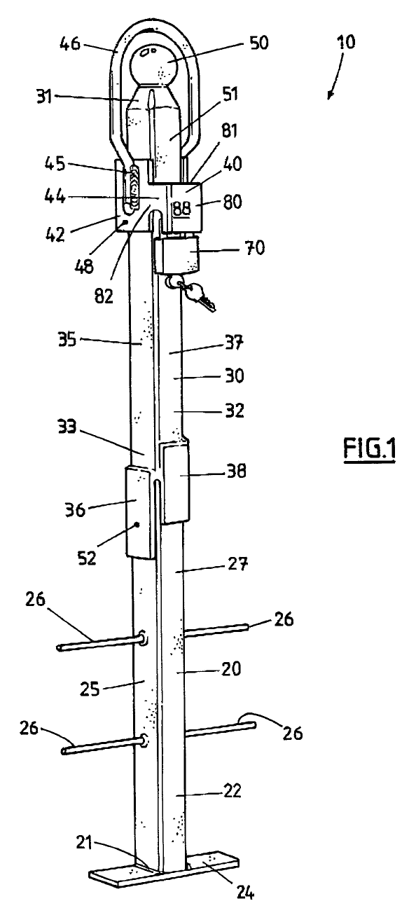

FIG. 1 is a perspective view of a security device shown in a first secured configuration in accordance with the present invention;

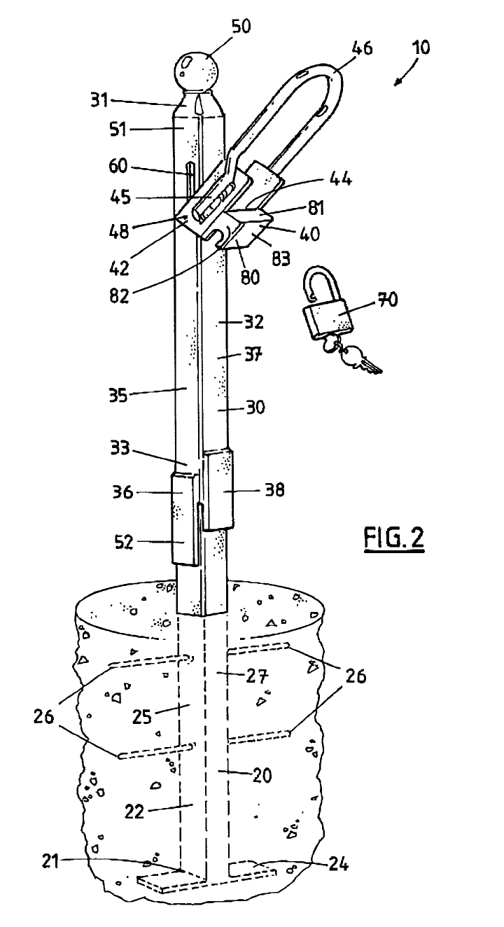

FIG. 2 is a perspective view of the security device shown in FIG. 1 in a second unsecured configuration;

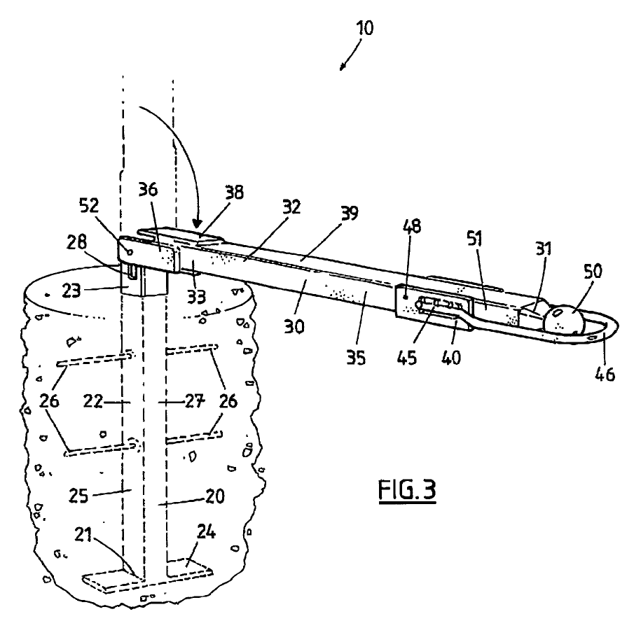

FIG. 3 is a perspective view of the security device shown in FIGS. 1 and 2 in a reclined configuration; and

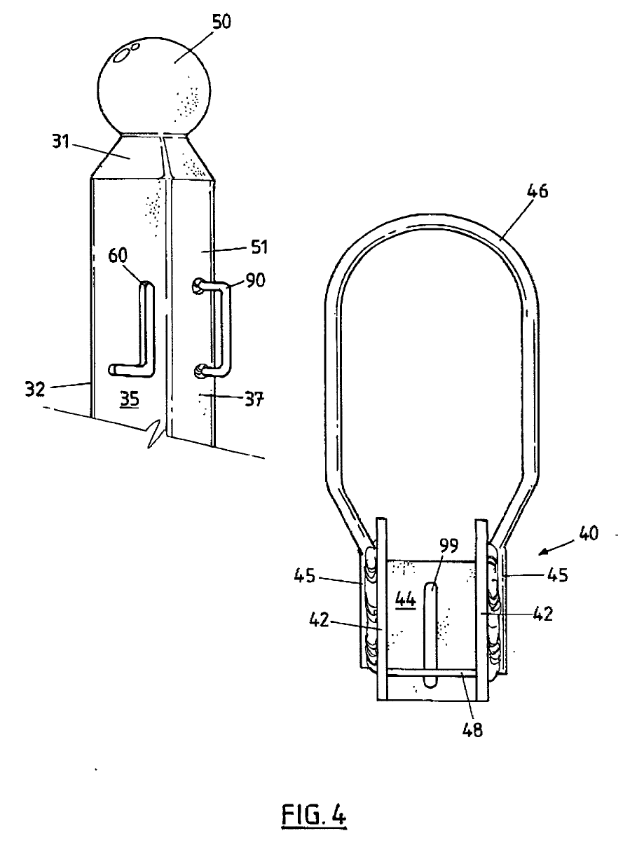

FIG. 4 is an exploded view of an upper portion of a columnar member and a pivotable member of the security device shown in FIGS. 1 to 3.

Referring to the FIGS. 1 to 4, there is shown a security device 10. The security device 10 includes a base member 20, a columnar member 30 pivotable between a first upright position and a second substantially horizontal reclined position, and a pivotable member 40 configurable in a first secured configuration and a second unsecured configuration.

The base member 20 includes a first elongate member 22, a substantially planar foot portion 24 laterally depending from a lowermost end 21 of the first elongate member 22, and a plurality of elongate lugs 26 laterally depending from opposing sides 25 of the first elongate member 22. Preferably, the foot portion 24 and the elongate lugs 26 are vertically aligned with one another, as shown in FIG. 1.

An uppermost portion 23 of the first elongate member 22 is provided with a pair of longitudinally aligned first elongate apertures 28, each first elongate aperture 28 being disposed in opposing sides 25 of the first elongate member 22.

The columnar member 30 includes a second elongate member 32, a tow ball 50 mounted on an uppermost end 31 of the second elongate member 32, a pair of first tongues 36, and a pair of second tongues 38. The first tongues 36 are longer than the second tongues 38.

Each first tongue 36 downwardly depends from a respective opposing side 35 of a lowermost end 33 of the second elongate member 32. Each second tongue 38 downwardly depends from respective front and rear sides 37, 39 of the lowermost end 33 of the second elongate member 32. The first tongues 36 are spaced apart from one another at a distance sufficiently large lor the first tongues 36 to overlap the uppermost portion 23 of the first elongate member 22. Similarly, the second tongues 38 are also spaced apart from one another at a distance sufficiently large for the second tongues 38 to overlap the uppermost portion 23 of the first elongate member 22 In this way, the first and second tongues 36, 38 of the columnar member 30 are telescopically slidable relative to the uppermost portion 23 of the first elongate member 22. Preferably, the first and second elongate members 22, 32 are each formed from a metal section having a substantially quadrangular cross section.

The first tongues 36 are provided with a first pin 52 laterally extending therebetween. The first pin 52 is slidably disposed within the first elongate aperture 28 of the base member 20. When the first pin 52 is slid into a lowermost reach of the first elongate aperture 28, the first and second tongues 36, 38 overlap the uppermost portion 23 of the first elongate member 22 as described previously When the first pin 52 is slid into an uppermost reach of the first elongate aperture 28, the second tongues 38 are short enough in length such that they clear front and rear sides 27, 29 of the first elongate member 22, and merely the first tongues 36 overlap the opposing sides 25 of the uppermost portion 23 of the first elongate member 22. Consequently, the columnar member 30 is pivotable about the first pin 52 between a first upright position as shown in FIGS. 1 and 2, and a second substantially horizontal reclined position as shown in FIG. 3

An uppermost portion 51 of the second elongate member 32 is provided with a pair of longitudinally aligned L-shaped apertures 60, each L-shaped aperture 60 being disposed in respective opposing sides 35 of the second elongate member 32. An upright portion of the L-shaped aperture 60 is disposed proximal to the front side 37 of the second elongate member 32.

The uppermost portion 51 of the second elongate member 32 is also provided with a longitudinally aligned loop 90 disposed on the front side 37 of the second elongate member 32 proximal to the L-shaped apertures 60.

The pivotable member 40 includes a pair of opposing side plate members 42, a front plate member 44, and an elongate inverted U-shaped member 46.

The opposing side plate members 42 are disposed parallel to and spaced apart from the opposing sides 35 of the second elongate member 32. The front plate member 44 is disposed parallel to and spaced apart from the front side 37 of the second elongate member 32. Side edges of the front plate member 44 are edgewise connected to respective front edges of the opposing side plate members 42, thereby forming a three-sided collar around the uppermost portion 51 of the columnar member 30.

Side arms 45 of the elongate inverted U-shaped member 46 are longitudinally aligned with and connected to the opposing side plate members 42 as shown in FIGS. 1 and 2.

The front plate member 44 is provided with a second aperture 99. The second aperture 99 is arranged to receive the longitudinally aligned loop 90 disposed on the front side 37 of the second elongate member 32. It is envisaged that the longitudinally aligned loop 90 will receive a locking device, such as a padlock 70, as shown in FIG. 1

The front plate member 44 is further provided with a housing 80 outwardly depending from the front plate member 44. The housing 80 comprises a substantially horizontal upper wall 81, a pair of substantially upright opposing parallel side walls 82, and a substantially upright front wall 83 disposed perpendicularly to the upper and side walls 81, 82. The purpose of the housing 80 is to house the locking device to protect it from weathering and prevent it irom being tampered with

The opposing side plate members 42 are provided with a second pin 48 laterally extending therebetween The second pin 48 is slidably disposed within the L-shaped aperture 60 of the columnar member 30 between a rearwardmost and forwardmost reach of a substantially horizontal portion of the L-shaped aperture 60, or between a lowermost and uppermost reach of the upright portion of the L-shaped aperture 60.

The pivotable member 40 is pivotable between a first secured configuration, wherein the pivotable member 40 is substantially longitudinally aligned with the columnar member 30, and a second unsecured configuration, wherein the pivotable member 40 is disposed at an upwardly inclined angle with respect to the columnar member 30.

In the first secured configuration the second pin 48 is slid into the rearwardmost reach of the L-shaped aperture 60. The opposing side plate members 42 and the front plate member 44 are disposed parallel to and spaced apart from the opposing sides 35 and the front side 37, respectively, of the second elongate member 32, as described previously. A mid-portion of the elongate inverted U-shaped member 46 is disposed above the tow ball 50. The second aperture 99 in the front plate member 44 receives the loop 90 disposed on the front side 37 of the second elongate member 32. It is envisaged that a locking device will be threaded through the loop 90 thus preventing the loop from disengagement from the second aperture 99.

In the second unsecured configuration the second pin 48 is slid into the forwardmost reach of the L-shaped aperture 60, anywhere between the lowermost and uppermost reach of the upright portion of the L-shaped aperture 60, such that the front plate member 44 is projected forwardly from the front side 37 of the columnar member 32.

Consequently, the loop 90 is caused to disengage from the second aperture 99 of the front plate member 44. The pivotable member 40 is pivoted about the second pin 48 to an upwardly inclined angle with respect to the columnar member 30, such that the mid-portion of the elongate inverted U-shaped member 46 is spaced apart from, and disposed at an upwardly inclined angle with respect to, the tow ball 50.

It is envisaged that the security device 10 will be permanently fixed in a location where it is desired to securely store boats, trailers, caravans and such like. The base member 20 is arranged, in use, to be mounted in the ground, preferably in reinforced concrete, to a depth wherein the first elongate apertures 28 are disposed above the ground Preferably, the foot portion 24 and the elongate lugs 26 are disposed in a direction perpendicular to the direction of pivotal movement of the columnar member 30.

The columnar member 30 is arranged, in use, to be pivoted to the second substantially horizontal reclined position so that a boat, caravan, trailer or such like can be towed to and from the location where it is stored without obstruction from the columnar member 30. The columnar member 30 is pivoted to the second substantially horizontal reclined position by sliding the columnar member 30 upwardly until the second tongues 38 clear the front and rear sides 27, 29 of the first elongate member 22. The columnar member 30 is then pivoted about the first pin 52.

It is envisaged, that a recess, arranged to receive the columnar member 30 when it is in the second substantially horizontal reclined position, could be provided in the ground adjacent to the security device 10 so that the rear side 39 of the columnar member 30 is disposed flushly with the ground. Alternatively, the columnar member 30 can be pivoted to the second substantially horizontal reclined position wherein the front side 37 of the columnar member 30 is contiguous with the ground level.

The boat, caravan, trailer, and such like is towed to the desired storage location and positioned adjacent the security device 10. Preferably the security device 10 is disposed rearwardly of the boat, caravan, trailer, and such like. The columnar member 30 is pivoted to the first upright position. The first and second tongues 36, 38 of the columnar member 30 are positioned such that they overlap the uppermost portion 23 of the base member 20, thereby preventing the columnar member 30 from pivoting of its own accord to the second substantially horizontal reclined position.

Attachment means are used to couple the boat, caravan, trailer, and such like to the ball 50. It is envisaged that the attachment means will loop around the tow ball 50 Access to the tow ball 50 is provided by pivoting the pivotable member 40 about the second pin 48 to the second unsecured configuration wherein the mid-portion of the elongate inverted U-shaped member 46 is spaced apart from, and disposed at an upwardly inclined angle with respect to, the tow ball 50 When the attachment means is in place, the pivotable member 40 is pivoted about the second pin 48 to the first secured configuration wherein the mid-portion of the elongate inverted U-shaped member 46 is disposed above the tow ball 50, thus preventing removal of the attachment means from the tow ball 50. It is envisaged that a padlock 70 will be threaded through the longitudinally aligned loop 90 in order to prevent the pivotable member 40 from being pivoted to the second unsecured configuration by an unauthorised party.

Modifications and variations as would be apparent to a skilled addressee are deemed to be within the scope of the present invention

1. A security device for boats, caravans, trailers and such like, comprising an upright member with means for engaging an attachment means to secure a boat, caravan, trailer or such like and a pivotable member configurable in a first secured configuration and a second unsecured configuration, wherein in the first secured configuration the pivotable member prevents the attachment means from being disengaged from the upright member and in the second unsecured configuration the pivotable member allows the attachment means to be disengaged from the upright member.

2. The device according to claim 1, wherein the pivotable member comprises a three sided collar surrounding an uppermost portion of the upright member, and an elongate inverted U-shaped member depending from opposing side plate members of the three sided collar.

3. The device according to claim 2, wherein the opposing side plate members are provided with a second pin laterally extending therebetween, the second pin being disposed within an aperture in the uppermost portion of the upright member, such that the U-shaped member is pivotable about the second pin between the first secured configuration and the second unsecured configuration.

4. The device according to claim 3, wherein a longitudinally aligned loop disposed on a front side of the upright member is arranged to protrude through a second aperture in the three-sided collar, and to receive a locking device to secure the pivotable member in the first secured configuration

5. The device according to claim 1, wherein tie upright member comprises a base member and a columnar member, wherein the columnar member is pivotable between a first upright position and a second substantially horizontal reclined position

6. The device according to claim 5, wherein the base member comprises a first elongate member, a substantially planar foot portion laterally depending from a lowermost end of the first elongate member, and a plurality of elongate lugs laterally depending from opposing sides of the first elongate member.

7. The device according to claim 6, wherein an uppermost portion of the first elongate member is provided with a pair of longitudinally aligned first elongate apertures, each first elongate aperture being disposed in opposing sides of the first elongate member

8. The device according to claim 7, wherein the columnar member includes a second elongate member, a pair of first tongues downwardly depending from opposing sides of a lowermost end of the second elongate member and a pair of second tongues downwardly depending from front and rear sides of the lowermost end of the second elongate member, the first tongues being provided with a first pin laterally extending therebetween.

9. The device according to claim 8, wherein the first pin is slidably disposed within the first elongate aperture of the first elongate member, such that when the first pin is slid into a lowermost reach of the first elongate aperture the first and second tongues overlap the uppermost portion of the first elongate member, and when the first pin is slid into the uppermost reach of the first elongate aperture, the second tongues clear front and rear sides of the first elongate member, thereby allowing the second elongate member to pivot about the first pin between a first upright position and a second substantially horizontal reclined position.

10. The device according to claim 8, wherein the first tongues are longer than the second tongues

11. The device according to claim 8, wherein the first and second tongues are telescopically slidable about the uppermost portion of the first elongate member

12. The device according to claim 6, wherein the foot portion and the elongate lugs are vertically aligned with one another.

13. The device according to claim 7, wherein the base member is arranged, in use, to be mounted in the ground to a depth wherein the first elongate apertures are disposed above the ground.

14. The device according to claim 6, wherein the foot portion and the elongate lugs are disposed in a direction perpendicular to the direction of pivotal movement of the columnar member

15. The device according to claim 1, wherein the means for engaging an attachment means to secure a boat, caravan, trailer or such like comprises a tow ball mounted on an uppermost end of the upright member.
